(19) United States
(12) Patent Application Publication
(10) Pub. No.: US 2025/0315035 A1
(43) Pub. Date: Oct. 9, 2025

(54) TECHNIQUES FOR MANAGING ARTIFICIAL INTELLIGENCE (AI) MODELS FOR SMART HOME SYSTEMS

(71) Applicant: Apple Inc., Cupertino, CA (US)

(72) Inventors: Akshath R. JAIN, Sunnyvale, CA (US); Jane L. NGUYEN, Sunnyvale, CA (US)

(21) Appl. No.: 19/088,455

(22) Filed: Mar. 24, 2025

Related U.S. Application Data
(60) Provisional application No. 63/631,002, filed on Apr. 8, 2024.

(51) Int. Cl. G05B 19/418

(52) U.S. Cl. CPC G05B 19/41885; G05B 2219/2642

(57) ABSTRACT

Disclosed herein are techniques for managing artificial intelligence (AI) models for smart home systems.

### CROSS-REFERENCE TO RELATED APPLICATIONS

The present application claims priority to U.S. Provisional Patent Application Ser. No. 63/631,002, entitled “TECHNIQUES FOR MANAGING ARTIFICIAL INTELLIGENCE (AI) MODELS FOR SMART HOME SYSTEMS” filed Apr. 8, 2024, which is hereby incorporated by reference in its entirety for all purposes.

### FIELD

The described embodiments set forth techniques for managing artificial intelligence (AI) models for smart home systems.

### BACKGROUND

Smart home devices refer to electronic devices that implement home automation functionalities. Smart home devices can include, for example, smart thermostat devices, smart lighting devices, smart lock devices, smart garage devices, smart camera devices, and so on. One key element of smart home systems are smart home hubs, which act as central control systems for various smart home devices that are included in homes. A given smart home hub can be implemented in different forms, such as a standalone device or a built-in component of other devices (e.g., a smart speaker, a home entertainment system, etc.), and is responsible for facilitating communications between the smart home devices and remote computing devices. In most cases, the smart home devices communicate with smart home hubs via wireless protocols (e.g., Wi-Fi, Bluetooth, etc.). Additionally, the smart home hubs typically connect to the home's Wi-Fi network to communicate with the remote computing devices—and, in most cases, gain access to the Internet. Access to the Internet can enable a variety of useful functionalities to be implemented, such as enabling individuals to control the smart home devices outside of the home, enabling activity logs associated with the smart home devices to be managed by one or more external services, and so on.

The number of categories of smart home devices in a given home typically corresponds to the number of smart home software applications (“smart home apps”) that are installed on the remote computing devices associated with the smart home. For example, in a smart home that includes (i) a single smart thermostat, (ii) twenty-five smart lighting devices, (iii) two smart lock devices, (iv) one smart garage device, and (v) four smart camera devices, one or more of the remote computing devices likely will include (i) a smart thermostat app, (ii) a smart lighting app, (iii) a smart lock app, (iv) a smart garage door app, and (v) a smart camera app. In this regard, the proliferation of available smart home devices has resulted in heavily fragmented systems that are cumbersome for individuals to manage. For example, an individual who resides in the foregoing example smart home may be required to individually access a majority of the applications during isolated events (e.g., morning routine, bed time routine, etc.) in order to configure the smart home according to the individual's preferences.

Various organizations have, in an effective manner, mitigated the foregoing issues by providing software applications and hardware devices that centralize the control of smart home devices under a unified management interface. In particular, the various smart home hubs of a given home can be configured to interact with a centralized management device—such as a smart home speaker that is capable of communicating with different smart home hubs (and, by extension, the smart home devices that communicate with the smart home hubs)—and the centralized management device can be accessed by a centralized smart home app executing on one or more of the remote computing devices. In this manner, a user of a remote computing device is able to interact with the various smart home devices through the (single) centralized smart home app, rather than numerous smart home apps that are highly specific to the various smart home devices.

Despite the foregoing advancements, a variety of challenges continue to persist within the smart home field, particularly with respect to utilizing artificial intelligence (AI) to learn and adapt to users' preferences, behaviors, and routines, in order to offer personalized experiences that enhance convenience and efficiency.

### SUMMARY

The described embodiments set forth techniques for managing artificial intelligence (AI) models for smart home systems.

One embodiment sets forth a method for managing activity predictions for a smart home system. According to some embodiments, the method can be implemented by a computing device associated with the smart home system, and includes the steps of (1) actively receiving smart home events associated with the smart home system, and (2) for each smart home event received: (i) providing, as input to a local artificial intelligence (AI) model, (a) the smart home event, and (b) a respective previous state output by the local AI model, (ii) receiving, as output from the local AI model, (a) a current state, and (b) an activity prediction, and (iii) in response to determining that a respective probability associated with the activity prediction satisfies a threshold: performing at least one action based at least in part on the activity prediction.

According to some embodiments, for a given smart home event received, the respective previous state is output by the local AI model in response to receiving, as input, a previous smart home event relative to the given smart home event.

According to some embodiments, the at least one action comprises: causing at least one smart home device associated with the smart home system to adjust at least one operational aspect of the at least one smart home device.

According to some embodiments, the method further includes the steps of (1) utilizing the local AI model to identify, among the smart home events, a subset of the smart home events that corresponds to one or more actions, wherein: (i) the subset of the smart home events comprises a predictive trigger, and (ii) the one or more actions comprise an ephemeral scene, and (2) generating: (i) a first recommendation to associate the ephemeral scene with the smart home system, (ii) a second recommendation to automatically implement the ephemeral scene when the predictive trigger is satisfied, or (iii) some combination thereof.

According to some embodiments, the local AI model is utilized to identify the subset of smart home events on a periodic basis or a conditional basis.

According to some embodiments, the method further includes the step of, in conjunction with determining, for a given smart home event received, that the respective probability associated with the activity prediction satisfies an anomaly threshold: causing the computing device, at least one other computing device, or some combination thereof, to output at least one notification associated with the smart home event.

According to some embodiments, the at least one notification is output in audio form, visual form, or some combination thereof, and conveys alert information about the smart home event.

Another embodiment sets forth another method for generating and distributing artificial intelligence (AI) models for smart home systems. According to some embodiments, the method can be implemented by at least one server computing device, and includes the steps of (1) receiving, from each computing device of a plurality of computing devices, a respective anonymized activity dataset that corresponds to a respective activity dataset managed by the computing device, (2) establishing at least one global artificial intelligence (AI) model based at least in part on the anonymized activity datasets, and (3) providing, to each computing device of the plurality of computing devices, the global AI model, to cause the computing device to: (i) generate or update a local AI model based at least in part on (a) the global AI model, and (b) the respective activity dataset, and (ii) utilize the local AI model to provide activity predictions based at least in part on activity information that is accessible to the computing device.

According to some embodiments, a given anonymized activity dataset includes a plurality of anonymized activity entries, and each anonymized activity entry of the plurality of anonymized activity entries corresponds to a respective activity entry of a plurality of activity entries included in the respective activity dataset managed by the computing device.

According to some embodiments, each anonymized activity entry of the plurality of anonymized activity entries includes: (1) a hash value that is generated by providing, to a cryptographic hash function, (i) a universally unique identifier (UUID) that corresponds to the respective activity dataset, (ii) an encryption key associated with the computing device, and (iii) a salt value associated with the given anonymized activity dataset, and (2) information associated with an activity to which the anonymized activity entry corresponds.

According to some embodiments, (1) a given computing device of the plurality of computing devices comprises a centralized management hub for a respective smart home system, (2) the given computing device is configured to interact with: (i) two or more controller devices associated with the respective smart home system, and (ii) at least one smart home device associated with the respective smart home system, (3) the given computing device, the two or more controller devices, the at least one smart home device, or some combination thereof, establish, at least in part, the respective activity dataset, and (4) the computing device and the two or more controller devices synchronize the respective activity dataset between one another as changes are made to the respective activity dataset.

According to some embodiments, the respective activity dataset managed by the given computing device corresponds to smart home events that are observed by the computing device, the two or more controller devices, the at least one smart home device, or some combination thereof, over a respective period of time.

According to some embodiments, the given computing device, the two or more controller devices, the at least one smart home device, or some combination thereof, are associated with a common user account.

According to some embodiments, providing the global AI model to the given computing device further causes the computing device to: utilize the respective local AI model to provide recommendations to (1) associate ephemeral scenes with the respective smart home system, and (2) automatically implement the ephemeral scenes when respective predictive triggers are satisfied.

Another embodiment sets forth yet another method for evolving artificial intelligence (AI) models that are utilized within smart home systems. According to some embodiments, the method can be implemented by at least one server computing device, and includes the steps of (1) distributing at least a first global AI model to a first subset of computing devices, and a second global AI model to a second subset of computing devices, wherein: (i) each computing device in the first subset of computing devices generates or updates a respective local AI model based at least in part on (a) the first global AI model, and (b) a respective activity dataset managed by the computing device, and (ii) each computing device in the second subset of computing devices generates or updates a respective local AI model based at least in part on (a) the second global AI model, and (b) a respective activity dataset managed by the computing device, (2) receiving first and second feedback information from at least one computing device of the first subset of computing devices and at least one computing device of the second subset of computing devices, respectively, (4) identifying, based at least in part on the first and second feedback information, a preferred AI model among the first or second global AI model, and (5) causing the preferred AI model to be utilized by at least the first and second subsets of computing devices.

According to some embodiments, the method further includes the steps of, prior to distributing the first and second global AI models: (1) receiving, from each computing device of a plurality of computing devices, a respective anonymized activity dataset that corresponds to a respective activity dataset managed by the computing device, (2) establishing the first global AI model based at least in part on the anonymized activity datasets and a first training regimen, and (3) establishing the second global AI model based at least in part on the anonymized activity datasets and a second training regimen that is distinct from the first training regimen.

According to some embodiments, a given anonymized activity dataset includes a plurality of anonymized activity entries, and each anonymized activity entry of the plurality of anonymized activity entries corresponds to a respective activity entry of a plurality of activity entries included in the respective activity dataset managed by the computing device.

According to some embodiments, (1) a given computing device of the plurality of computing devices comprises a centralized management hub for a respective smart home system, (2) the given computing device is configured to interact with: (i) two or more controller devices associated with the respective smart home system, and (ii) at least one smart home device associated with the respective smart home system, (3) the given computing device, the two or more controller devices, the at least one smart home device, or some combination thereof, establish, at least in part, the respective activity dataset, and (4) the computing device and the two or more controller devices synchronize the respective activity dataset between one another as changes are made to the respective activity dataset.

According to some embodiments, the method further includes the step of establishing an updated training regimen that is based at least in part on the first and second feedback information.

According to some embodiments, the method further includes the steps of prior to distributing the preferred AI model: (1) receiving, from each computing device of the plurality of computing devices, a respective updated anonymized activity dataset that corresponds to the respective activity dataset managed by the computing device, and (2) updating the preferred AI model based at least in part on the updated anonymized activity datasets and the updated training regimen.

According to some embodiments, the first and second feedback information indicates utilization metrics, prediction accuracy metrics, or some combination thereof, associated with the first and second global AI models, respectively.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIG. 2 illustrates a conceptual diagram of activity information that can be collected by a given smart home system under an example scenario, according to some embodiments.

FIG. 3A illustrates a conceptual diagram of activity information that can be analyzed by a given smart home system to generate relevant predictions, according to some embodiments.

FIG. 3B illustrates a conceptual diagram of how the different inputs to and outputs from the personalized AI model described in conjunction with FIG. 3A can be utilized, according to some embodiments.

FIG. 3C illustrates a method for managing activity predictions for a smart home system, according to some embodiments.

FIG. 4A illustrates a conceptual diagram of a technique for generating and distributing AI models for smart home systems, according to some embodiments.

FIG. 4B illustrates a method for generating and distributing artificial intelligence (AI) models for smart home systems, according to some embodiments.

FIG. 5A illustrates a conceptual diagram of a technique for evolving artificial intelligence (AI) models that are utilized within smart home systems, according to some embodiments.

FIG. 5B illustrates a method for evolving artificial intelligence (AI) models that are utilized within smart home systems, according to some embodiments.

FIG. 6 illustrates conceptual diagrams of user interfaces that can be utilized to enable users to interact with recommendations, according to some embodiments.

FIG. 7 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The described embodiments set forth techniques for managing artificial intelligence (AI) models for smart home systems.

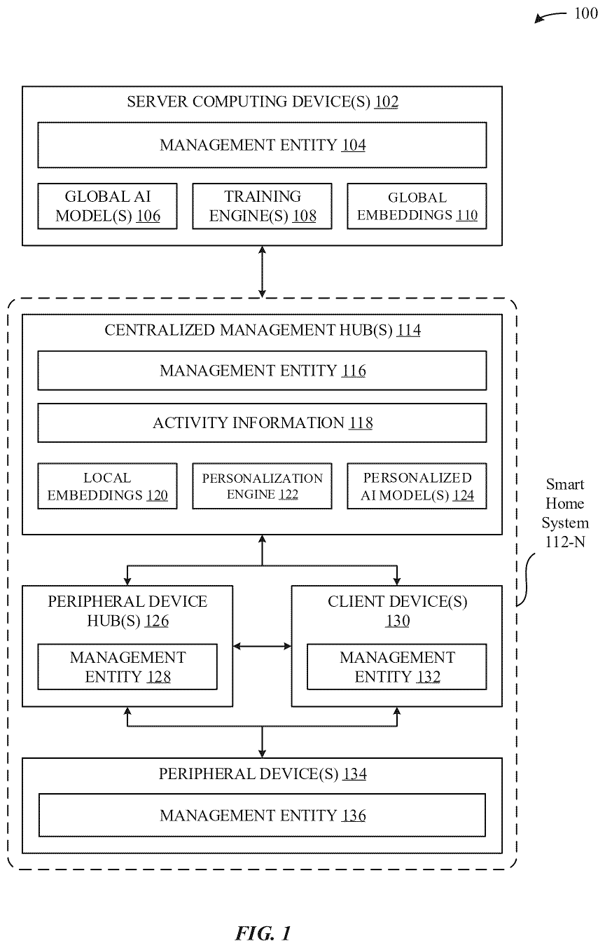

FIG. 1 illustrates a block diagram of different components of a system 100 that can be configured to implement the various techniques described herein, according to some embodiments. As shown in FIG. 1, the system 100 can include one or more server computing devices 102. The system 100 can also include one or more smart home systems 112, which each logically encapsulate a subset of various smart home devices that are included in a given home, establishment, and so on. As shown in FIG. 1, a given smart home system 112 can include one or more centralized management hubs 114, one or more peripheral device hubs 126, one or more client devices 130, and one or more peripheral devices 134. It is noted that the computing devices encapsulated within a given smart home system 112 are not meant to be limiting, and that any amount, type, form, etc., of computing device(s) can be included in the smart home system 112, consistent with the scope of this disclosure.

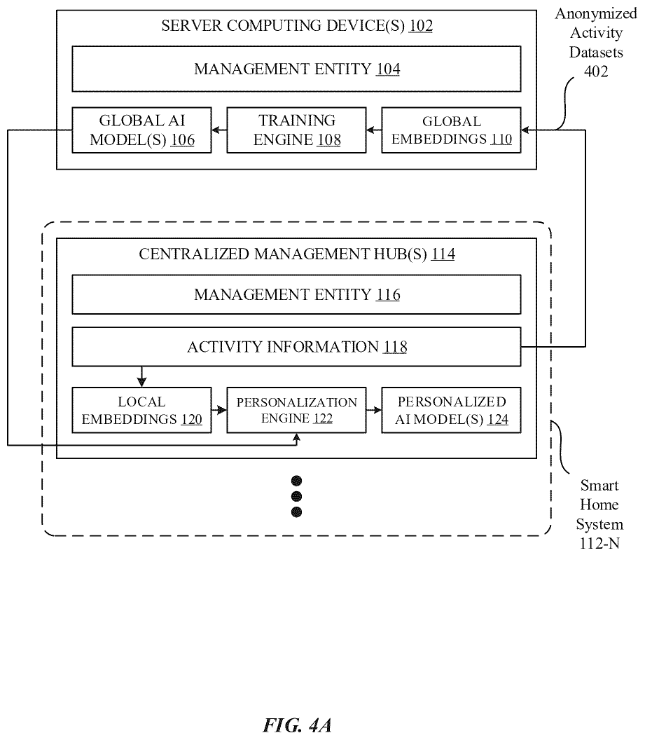

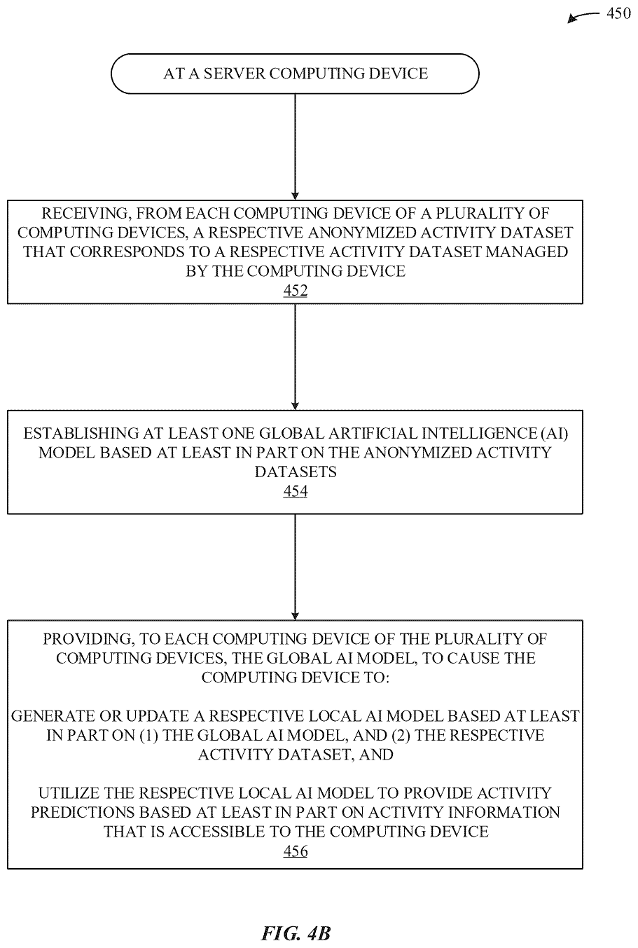

According to some embodiments, one or more of the server computing devices 102 can represent an entity, e.g., an organization, a service, etc., that provides various functionalities, such as cloud-based services over the Internet. According to some embodiments, a given server computing device 102 can include a management entity 104 that is configured to interface with the centralized management hubs 114, the peripheral device hubs 126, the client devices 130, the peripheral devices 134, and the like. According to some embodiments, the management entity 104 can be configured to implement training engines 108 that are configured to generate, update, fine-tune, etc., global AI models 106 based on global embeddings 110 (and other relevant information, where appropriate). According to some embodiments, and as described below in conjunction with FIGS. 4A-4B, the global embeddings 110 can be established using anonymized activity datasets that are (1) based on activity information 118 that is collected by the smart home systems 112, and (2) provided by the smart home systems 112 to the management entity 104. According to some embodiments, and as also described below in conjunction with FIGS. 4A-4B, the management entity 104 can provide global AI models 106 to smart home systems 112 (e.g., centralized management hubs 114, client devices 130, etc., of the smart home systems 112). According to some embodiments, and as further described below in conjunction with FIGS. 4A-4B, the smart home systems 112 can implement personalization engines 122 that utilize the global AI models 106—along with local embeddings 120 that are based on the activity information 118 (and/or other relevant information)—to generate, train, etc., personalized AI models 124.

As a brief aside, it is noted that the AI models described herein can represent small language models (SLMs), large language models (LLMs), rule-based models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and so on. It is noted that the foregoing examples are not meant to be limiting, and that any number, type, form, etc., of AI model(s), can be implemented by any of the entities illustrated in FIG. 1, without departing from the scope of this disclosure. It is further noted that the techniques described herein can also be implemented using non-AI-based approaches, such as rules-based systems, knowledge-based systems, and so on, consistent with the scope of this disclosure.

According to some embodiments, each client device 130 can have any number of software applications (smart home apps or otherwise) installed thereon and can implement a management entity 132 that is configured to facilitate installations, executions (e.g., loading, displaying, etc.), and so on, of the software applications. Each client device 130 can also be associated with a user account (not illustrated in FIG. 1) that is known to the server computing device 102. Such an association can be established, for example, when a user of the client device 130 provides the requisite information to create, log into, etc., a user account using the client device 130. The user account can also be associated with centralized management hubs 114, the peripheral device hubs 126, the peripheral devices 134, etc., that are part of the smart home system 112 associated with the client devices 130, e.g., by logging in the user account on the hubs/devices, by providing credentials associated with the user account to the hubs/devices, and so on. According to some embodiments, a user account for a user can include username/password information, contact information associated with the user, demographic information associated with the user, and so on. It is noted that the foregoing examples are not meant to be limiting, and that the user accounts can store any user-related (or other) information, at any level of granularity, consistent with the scope of this disclosure.

According to some embodiments, a given peripheral device 134 executing a management entity 136 can represent a device that is capable of performing different functionalities. For example, the peripheral device 134 can represent any smart home device, e.g., a smart speaker, a smart thermostat, a smart lock, a smart camera, a smart light bulb/light switch, a smart plug, a smart smoke detector, a smart doorbell, a smart garage door opener, a smart irrigation system, a smart appliance, a smart window blind, a smart air purifier, a smart vacuum cleaner, and the like. As described herein, a given peripheral device 134 can be configured to interface with one or more peripheral device hubs 126. For example, a group of peripheral devices 134 that represent smart light switches can be configured to communicate with a peripheral device hub 126 using standardized, proprietary, etc., wireless communications. In another example, a group of peripheral devices that represent smart window blinds can be configured to communicate with a peripheral device hub 126 using wired communications.

In the foregoing examples, one or more of the client devices 130 typically include individual software applications (“smart home apps”) that correspond to respective ones of the peripheral device hubs 126 and enable the peripheral devices 134 to be controlled via the peripheral device hubs 126. In particular, the smart home apps can be configured to interface with management entities 128 executing on the peripheral device hubs 126 in order to access the available functionalities of the peripheral devices 134 controlled by the peripheral device hubs 126. It is noted, however, that some peripheral devices 134 can be configured to operate without the need for peripheral device hubs 126. For example, a peripheral device 134 that represents a smart garage door opener can be configured to interface directly with one or more of the client devices 130, the centralized management hub 114, and so on, without the involvement of a peripheral device hub 126. In this example, one or more of the client devices 130 can include a smart home app that enables the client devices 130 to communicate directly with the smart garage door opener (e.g., over a connection formed using Wi-Fi, Bluetooth, the Internet, etc.). In another example, the smart garage door opener can be configured to interface with the centralized management hub 114 independent from any other devices.

As described herein, the implementation of various peripheral device hubs 126/peripheral devices 134 can result in a fragmented system that can be cumbersome for individuals to manage. In particular, an individual may be required to individually access different smart home apps each time they would like to interact with the peripheral devices 134. Accordingly, under a given smart home system 112, one or more centralized management hubs 114 that include a management entity 116 can be employed to centralize the functionalities of the peripheral device hubs 126/peripheral devices 134 under a common interface. In this regard, a given centralized management hub 114 can represent a centralized management device that is capable of communicating with any number of peripheral device hubs 126, peripheral devices 134, and/or client devices 130. In one example, a centralized management hub 114 can represent a standalone device that is solely designed to centralize the control of different peripheral devices 134, e.g., in conjunction with a peripheral device activity user interface (UI) implemented on the client devices 130 (the details of which are described below in greater detail). In another example, the centralized management hub 114 can represent a device that provides additional functionalities to those described above, such as smart home device functionalities. For example, the centralized management hub 114 can provide smart speaker functionalities, media streaming device functionalities, and the like, in addition to the centralization functionalities described herein.

It is noted that the foregoing examples are not meant to be limiting, and that the centralized management hub 114 can be configured to provide any number of functionalities (in addition to the centralization functionalities described herein), consistent with the scope of this disclosure. Additionally, it is noted that the embodiments do not rely on one or more of the centralized management hubs 114 to provide the functionalities described herein. In particular, the functionalities of the centralized management hub 114 can be implemented, in whole or in part, by one or more of the peripheral device hubs 126, the peripheral devices 134, the client devices 130, and/or other device(s) not illustrated in FIG. 1. For example, one or more of the peripheral device hubs 126, the client devices 130, and/or the peripheral devices 134 can be configured to interface directly/indirectly with one another, the server computing devices 102, etc., consistent with the scope of this disclosure.

It should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

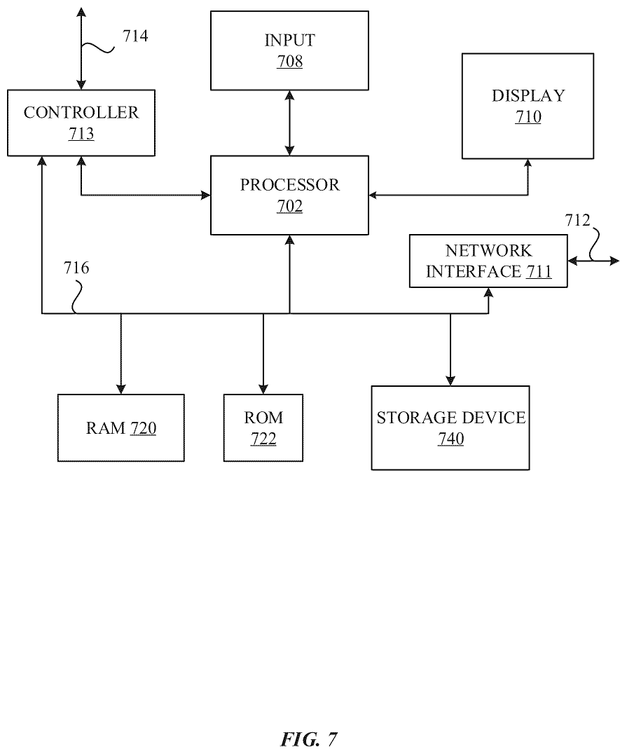

A more detailed explanation of these hardware components is provided below in conjunction with FIG. 7. It should additionally be understood that the computing devices can include additional entities that enable the implementation of the various techniques described herein consistent with the scope of this disclosure. It should additionally be understood that the entities described herein can be combined or split into additional entities consistent with the scope of this disclosure. It should further be understood that the various entities described herein can be implemented using software-based or hardware-based approaches consistent with the scope of this disclosure.

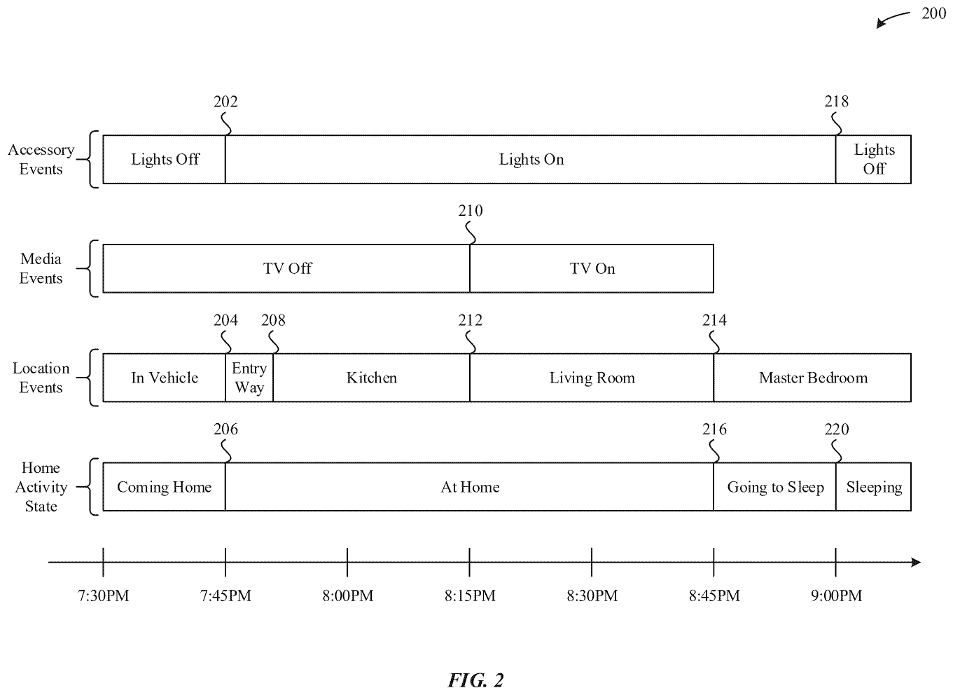

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2, 3A-3C, 4A-4B, 5A-5B, and 6-7.

FIG. 2 illustrates a conceptual diagram 200 of activity information 118 that can be collected by a given smart home system 112 under an example scenario, according to some embodiments. In particular, FIG. 2 illustrates an example scenario that involves an evening routine of a user associated with a smart home system 112. As shown in FIG. 2, from 7:30 PM to 7:45 PM, it is determined, through location events, that the user is in a vehicle. The location events can be detected, analyzed, etc., for example, by a client device 130 that belongs to the user, and that has access to information that enables the client device 130 to effectively determine that the user is in a vehicle. Such information can include, for example, pairing information that indicates the client device 130 is actively paired to an infotainment system of the vehicle, location information that indicates the client device 130 is traveling along a path in a manner that is consistent with vehicular travel, and so on. It is noted that the foregoing examples are not meant to be limiting, and that the client device 130 (and/or other devices) can effectively identify that the user is in a vehicle based on any amount, type, form, etc., of information, at any level of granularity, consistent with the scope of this disclosure.

As shown in FIG. 2, it is also determined that a “Coming Home” home activity state is active between 7:30 PM and 7:45 PM. This “Coming Home” state can be determined, for example, by identifying that the path the user is traveling in the vehicle indicates that the user is heading toward a physical home, building, etc., associated with the smart home system 112. The home activity state can also be determined, for example, by accessory events that indicate that the lights are off throughout the user's home, and that the TV is off. Again, it is noted that the foregoing approaches for identifying location events and home activity states—as well as the accessory events and media events described below—are merely exemplary, and that the devices included in the smart home system 112 (and/or other devices) can utilize any number of approaches for effectively identifying and determining the events and states described herein, consistent with the scope of this disclosure.

In any case, as shown in FIG. 2, at 7:45 PM, multiple events take place as the user arrives at the user's home. In particular, an event 202 involves the lights being turned on, and an event 204 involves the involves the user transitioning from being located in the vehicle to being located in the entry way of the home (e.g., as determined by a smart door lock, by the location of the client device 130, by other devices positioned in proximity to the entry way, etc.). In turn—and, in conjunction with the events 202/204 (and/or other events not illustrated in FIG. 2), the home activity state can transition to an “At Home” state at event 206. Next, and as shown in FIG. 2, an event 208 involves user transitioning from being in the entry way to being in the kitchen, where the user remains until 8: 15PM. Next, and as shown in FIG. 2, events 210 and 212 involve the user turning on a television, and the user transitioning from being in the kitchen to being in the living room, respectively. The user then remains in the living room from 8:15 PM to 8:45 PM. In turn, and as shown in FIG. 2, events 214 and 216 involve the user transitioning from being in the living room to being in the master bedroom, and the home activity state transitioning from “At Home” to “Going to Sleep”, respectively. Finally, at 9:00 PM, an event 218 involves the user turning the lights off, and an event 220 involves the home activity state transitioning from “Going to Sleep” to “Sleeping”.

Accordingly, events 202-220, taken both individually and sequentially, constitute transitions that are relevant to effectively making predictions about the user's next action(s). As described in greater detail herein, such predictions can be utilized to provide useful recommendations to users, including providing prompts at relevant times to take action(s) that the user otherwise is about to perform manually (e.g., by physically interacting with smart home devices, by applying relevant settings in smart home device applications, etc.). Such predictions can also be utilized to provide prompts to create ephemeral scenes that constitute specific settings for one or more smart home devices, and, optionally, to automatically apply ephemeral scenes when relevant conditions are satisfied.

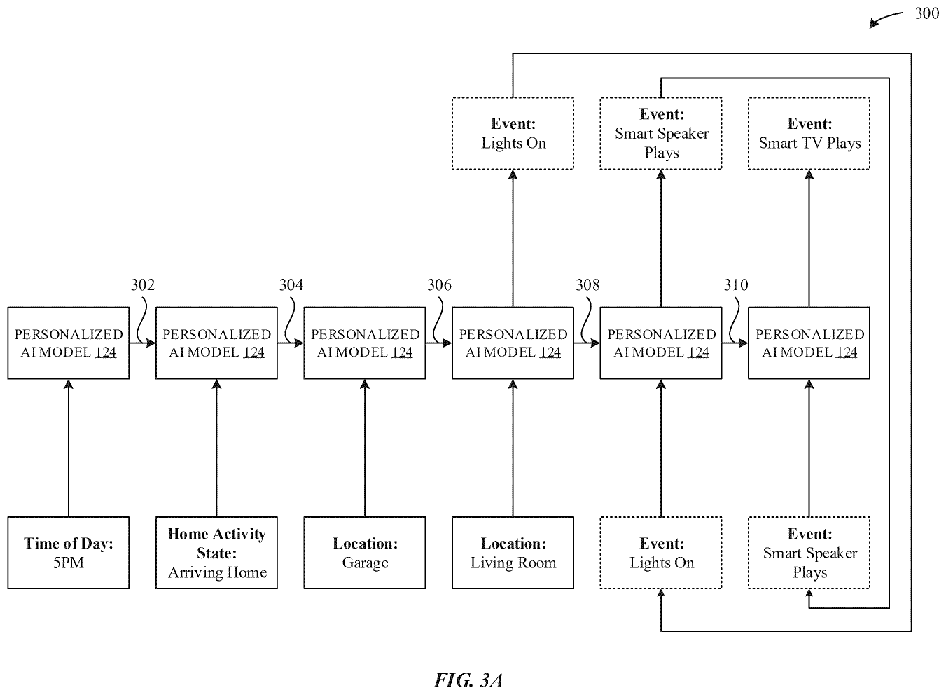

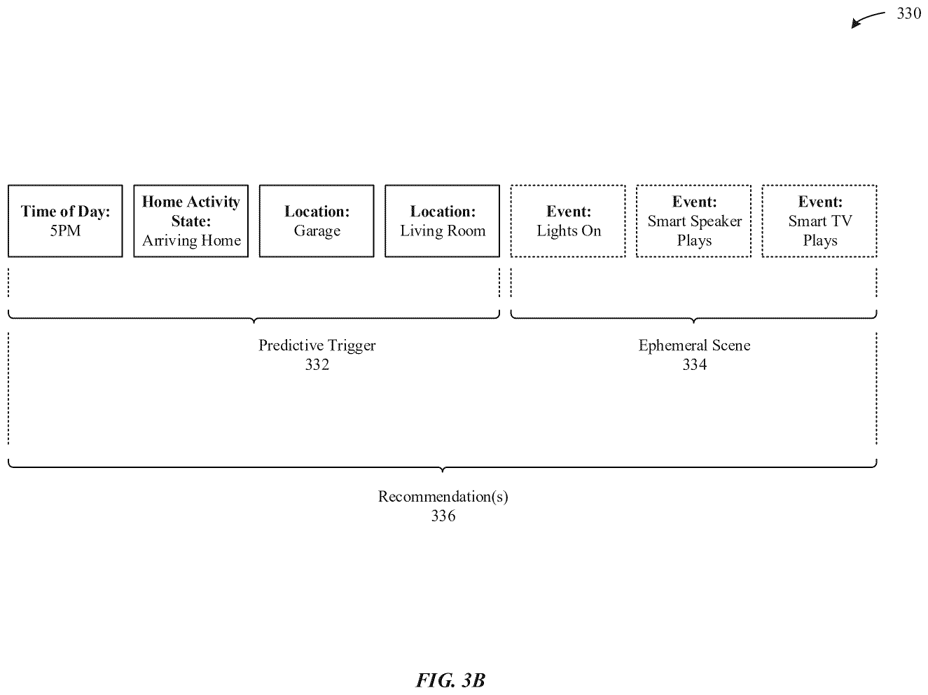

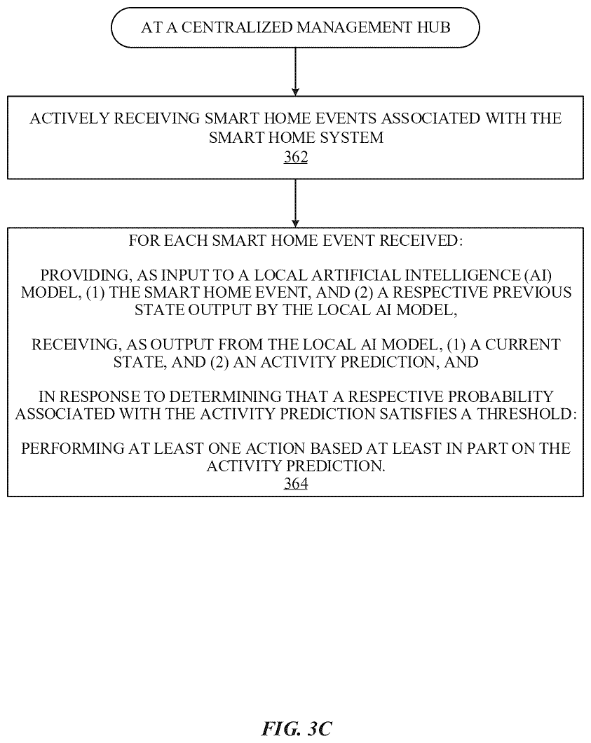

FIG. 3A illustrates a conceptual diagram 300 of activity information 118 that can be analyzed by a given smart home system 112 to generate relevant predictions, according to some embodiments. As shown in FIG. 3A, the smart home system 112 can utilize a personalized AI model 124 in an autoregressive manner, which involves operating the personalized AI model 124 as a time-series model that predicts future values based on past observations within the same series. In particular, the personalized AI model 124 can be operated, utilized, etc., in accordance with the principle that each observation in a time series can be considered as a linear combination of its past values, by incorporating a set number of lagged observations to forecast the next data point. Mathematically, the personalized AI model 124 can express each observation as a function of its previous values, with coefficients determined through estimation techniques like least squares. By iteratively updating predictions using actual values, the personalized AI model 124 can capture temporal dependencies and produce forecasts, predictions, etc., that reflect the underlying patterns in the activity information 118.

Accordingly, and as shown in FIG. 3A, the personalized AI model 124 receives an input that is representative of the time of the day (5 PM) that the personalized AI model 124 is being utilized. When the personalized AI model 124 generates, in response to the input, at least one prediction that satisfies a threshold level of probability, the personalized AI model 124 can output an updated state, as well as the at least one prediction. Otherwise, when no predictions satisfy the threshold level of probability, the personalized AI model 124 can output the updated state, and wait for additional input. Accordingly, in the example illustrated in FIG. 3A, the personalized AI model 124 does not generate a prediction based alone on an input indicating that the time of the day is 5 PM (e.g., which can be provided to the personalized AI model 124, e.g., when the personalized AI model 124 is utilized in attempt to generate predictions). In this regard, and as shown in FIG. 3A, the personalized AI model 124 generates an updated state 302, and then waits for additional input.

Next, a second input is made to the personalized AI model 124, where the second input indicates a change in the home activity state to “Arriving Home”. In turn, the personalized AI model 124 does not generate a prediction based alone on the second input and the updated state 302. In this regard, the personalized AI model 124 generates an updated state 304, and then waits for additional input. Next, a third input is made to the personalized AI model 124, where the third input indicates a change in the user's location to the garage. In turn, the personalized AI model 124 does not generate a prediction based alone on the third input and the updated state 304, but generates an updated state 306, and then waits for additional input.

Next, a fourth input is made to the personalized AI model 124, where the fourth input indicates a change in the user's location to the living room. In turn, the personalized AI model 124 generates a prediction based on the fourth input and the updated state 306—specifically, a prediction that the user is about to turn the lights on in the home. Again, the aforementioned prediction can be utilized when the prediction is associated with a probability value that satisfies a threshold. For example, if the threshold is seventy-five percent (75%), and the probability value associated with the prediction is ninety percent (90%), then the prediction can be utilized. As shown in FIG. 3A, the personalized AI model 124 also generates an updated state 308.

At this juncture, different options can be carried out in response to the prediction that it is highly likely that the user is about to turn the lights on in the home. For example, when the personalized AI model 124 is being utilized to process various inputs derived from historical events that already occurred (i.e., rather than live events that are occurring), additional inputs (also derived from the historical events) can be provided to the personalized AI model 124 to identify one or more triggers that correspond to events that occur. In another example, when the personalized AI model 124 is being utilized to process live events that are occurring, action(s) can be immediately taken on the prediction, and/or the additional/future events can be provided to the personalized AI model 124 to generate additional predictions/take additional action(s).

In any case, as shown in FIG. 3A, the updated state 308, and, optionally, the prediction that the user is about to turn the lights on in the home, can be provided to the personalized AI model 124 as fifth inputs. In turn, the personalized AI model 124 can generate a prediction based on the fifth inputs—specifically, a prediction that the user is about to begin media playback on a smart speaker (e.g., based on the threshold satisfaction approaches described herein). The personalized AI model 124 also generates an updated state 310.

At this juncture, the aforementioned options can be carried out in response to the prediction that the user is about to begin media playback on the smart speaker. In any case, as shown in FIG. 3A, the updated state 310, as well as the prediction that the user is about to begin media playback on the smart speaker, can be provided to the personalized AI model 124 as sixth inputs. In turn, the personalized AI model 124 can generate a prediction based on the sixth inputs—specifically, a prediction that the user is about to begin media playback on a smart TV. In turn, and as described herein, the aforementioned options can be carried out in response to the prediction that the user is about to begin media playback on a smart TV. The personalized AI model 124 can also generate an updated state 310. Subsequent predictions/updated states can be output by the personalized AI model 124 in response to receiving subsequent inputs, to thereby enable the aforementioned options to be carried out where appropriate.

FIG. 3B illustrates a conceptual diagram 330 of how the different inputs to and outputs from the personalized AI model 124 described above in conjunction with FIG. 3A can be utilized, according to some embodiments. For example, as shown in FIG. 3B, the personalized AI model 124 can be utilized to identify that when the user (1) arrives at home, (2) enters into the garage, and (3) enters into the living room, the user typically turns on the lights, begins media playback on the smart speaker, and also begins media playback on the smart TV. In this regard, a predictive trigger 332 can correspond to the user arriving at home around 5 PM, entering into the garage, and then entering into a living room, and an ephemeral scene 334 can correspond to the lights being turned on, as well as media being played back on the smart speaker and the smart TV. In turn, recommendations 336 can be provided based on the predictive trigger 332 and the ephemeral scene 334.

In one example, a recommendation can be provided to create an ephemeral scene (e.g., within a configuration associated with the smart home system 112) that causes appropriate smart home devices to update their respective settings any time the ephemeral scene 334 is activated. In another example, a recommendation can be provided (e.g., by one or more of the devices belonging to the smart home system 112) to implement the ephemeral scene 334 each time the conditions encompassed by the predictive trigger 332 are satisfied. It is noted that the foregoing examples are not meant to be limiting, and that the recommendations described herein can include any amount, type, form, etc., of recommendation(s), at any level of granularity, consistent with the scope of this disclosure.

FIG. 3C illustrates a method 360 for managing activity predictions for a smart home system, according to some embodiments. As shown in FIG. 3C, the method 360 begins at step 362, where a centralized management hub 114 actively receives smart home events associated with the smart home system (e.g., as described above in conjunction with FIG. 3A).

At step 364, the centralized management hub 114 performs the following steps for each smart home event received: (1) providing, as input to a local artificial intelligence (AI) model, (i) the smart home event, and (ii) a respective previous state output by the local AI model, (2) receiving, as output from the local AI model, (i) a current state, and (ii) an activity prediction, and (3) in response to determining that a respective probability associated with the activity prediction satisfies a threshold: performing at least one action based at least in part on the activity prediction (e.g., as described above in conjunction with FIG. 3A).

FIG. 4A illustrates a conceptual diagram 400 of a technique for generating and distributing AI models for smart home systems 112, according to some embodiments. As shown in FIG. 4A, and as previously described herein, smart home systems 112 can gather activity information 118 from the respective devices that belong to the smart home systems 112. According to some embodiments, devices that are members of a given smart home system 112 can be configured to gather and share activity information 118 information among one another so that the activity information 118 is synchronized between the devices. For example, as a given device (e.g., a centralized management hub 114, a peripheral device hub 126, a client device 130, a peripheral device 134, etc.) gathers information about events, activities, state changes, etc., the device can write relevant information to the activity information 118 that is managed by the centralized management hub 114. In another example, the device can locally-store the information, and then periodically, conditionally, etc., provide the data to the centralized management hub 114. It is noted that the foregoing examples are not meant to be limiting, and that the synchronization techniques described herein can be implemented using any approach, at any level of granularity, consistent with the scope of this disclosure.

In any case, and as shown in FIG. 4A, the activity information 118 can be anonymized and provided by the smart home systems 112 to one or more server computing devices 102 in the form of anonymized activity datasets 402. According to some embodiments, activity information 118 belonging to a given smart home system 112 can be stored in the form of one or more activity datasets, where each activity dataset includes activity entries that effectively log different activities that have occurred/are occurring within the smart home system 112, e.g., accessory events, media events, location events, home activity states, and so on, as described above in conjunction with FIG. 2. According to some embodiments, each activity entry can be associated with a universally unique identifier (UUID) that corresponds to the respective activity dataset (e.g., a unique identifier that corresponds to the smart home system 112).

Accordingly, to generate an anonymized activity dataset 402 that corresponds to a given activity dataset, the smart home system 112 (e.g., the management entity 104 of a centralized management hub 114) can, for each activity entry in the given activity dataset, replace the UUID with a hash value that is generated by providing, to a cryptographic hash function, (1) the UUID, (2) an encryption key associated with the smart home system 112, and (3) a salt value associated with the given activity dataset. In this manner, the anonymized activity dataset 402 achieves the benefit of being anonymous to the extent that the server computing device 102 is unable to identify the smart home system 112 from which the underlying activity dataset was obtained. The anonymized activity dataset 402 also achieves the benefit of being consistent such that a timeline of events can be identified across two or more distributed devices within the smart home system 112, which can enhance the overall accuracy by which predictions are made. The anonymized activity dataset 402 further achieves the benefit of being disjoint, such that the anonymized activity dataset 402 cannot be linked with other anonymized activity datasets 402 (e.g., in an attempt to identify smart home systems 112). It should be appreciated that the benefits described above are merely exemplary, and that additional benefits can be achieved through the anonymization techniques described herein.

According to some embodiments, the server computing device 102 can utilize the anonymized activity datasets 402 to form global embeddings 110. In turn, a training engine 108 can utilize the global embeddings 110 to generate, update, etc., one or more global AI models 106. The global AI models 106 can then be distributed to the smart home systems 112. According to some embodiments, a given smart home system 112—e.g., a centralized management hub 114 of the given smart home system 112—can implement a personalization engine 122 that receives the global AI model 106. In turn, the personalization engine 122 can utilize (1) the global AI model 106, along with (2) local embeddings 120 that are based on activity information 118 (and any other relevant information), to generate one or more personalized AI models 124 that effectively represent a global AI model 106 that is specifically trained based upon/fine-tuned to effectively provide predictions for the devices, behaviors observed within, etc., the smart home system 112. It is noted that the foregoing examples are not meant to be limiting, and that the personalized AI model 124 can be generated, trained, fine-tuned, etc., based upon any amount, type, form, etc., of AI model(s), information, etc., at any level of granularity, consistent with the scope of this disclosure.

FIG. 4B illustrates a method 450 for generating and distributing artificial intelligence (AI) models for smart home systems, according to some embodiments. As shown in FIG. 4B, the method 450 begins at step 452, where a server computing device 102 receives, from each computing device of a plurality of computing devices, a respective anonymized activity dataset that corresponds to a respective activity dataset managed by the computing device (e.g., as described above in conjunction with FIG. 4A).

At step 454, the server computing device 102 establishes at least one global artificial intelligence (ai) model based at least in part on the anonymized activity datasets (e.g., as described above in conjunction with FIG. 4A).

At step 456, the server computing device 102 provides, to each computing device of the plurality of computing devices, the global AI model, to cause the computing device to: (1) generate or update a respective local AI model based at least in part on (i) the global AI model, and (ii) the respective activity dataset, and (2) utilize the respective local AI model to provide activity predictions based at least in part on activity information that is accessible to the computing device (e.g., as described above in conjunction with FIG. 4A).

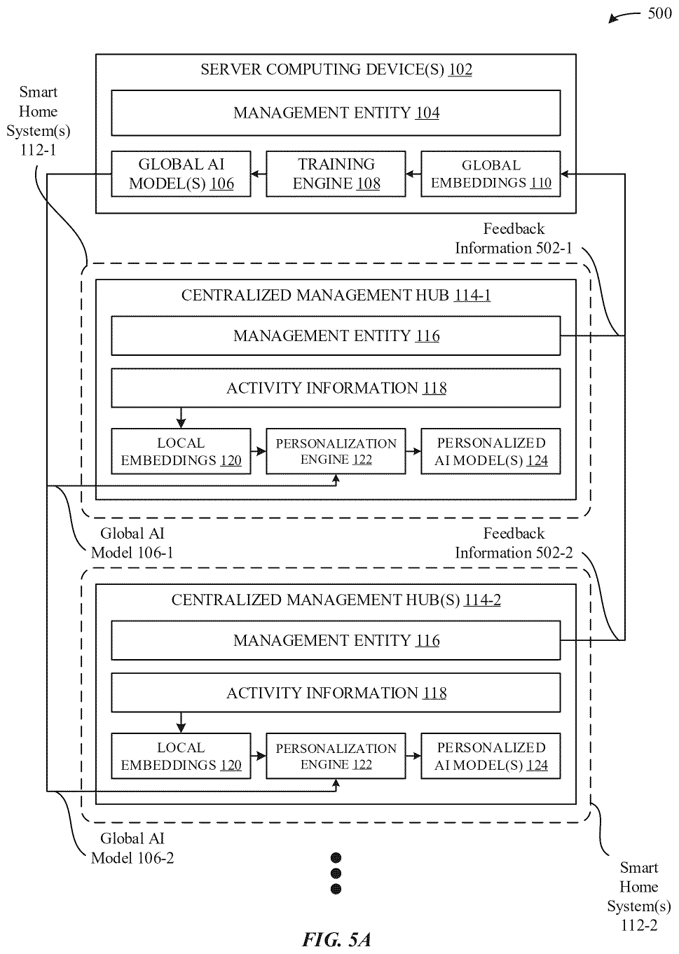

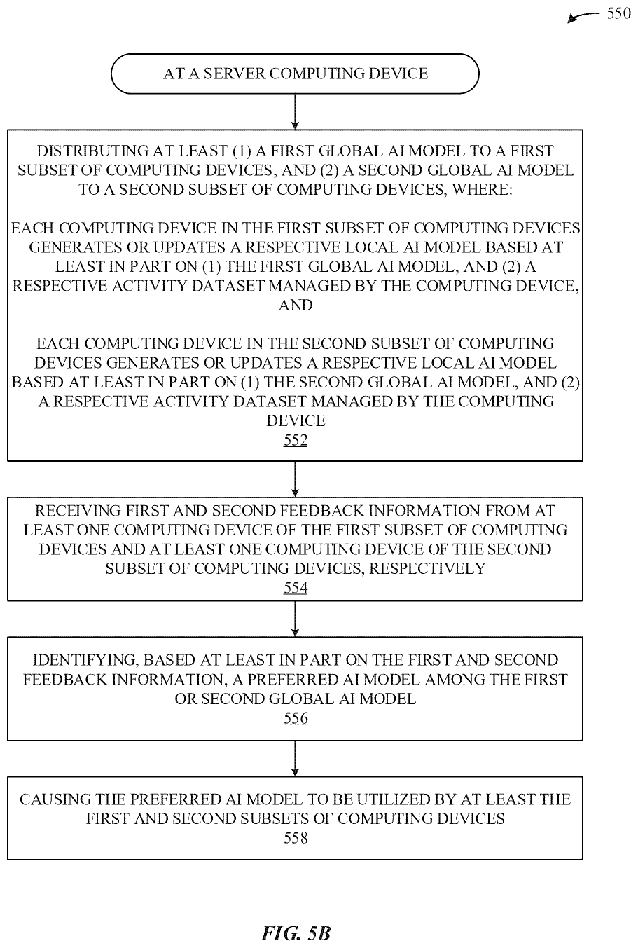

FIG. 5A illustrates a conceptual diagram 500 of a technique for evolving artificial intelligence (AI) models that are utilized within smart home systems, according to some embodiments. As shown in FIG. 5A, the server computing device 102 can establish at least two global AI models 106, e.g., using techniques similar to those described above in conjunction with FIGS. 4A-4B. For example, the server computing device 102 can establish a global AI model 106-1 using a first approach, which can include utilizing a first set of global embeddings 110, a first training technique, and so on. The server computing device 102 can also establish a global AI model 106-2 using a second approach, which can include utilizing a second set of global embeddings 110, a second training technique, and so on. In turn, the global AI model 106-1 can be provided to one or more smart home systems 112-1, and the global AI model 106-2 can be provided to one or more smart home systems 112-2.

The global AI models 106-1/106-2 can be utilized by the smart home systems 112-1/112-2, respectively, to generate respective personalized AI models 124, e.g., using the techniques described above in conjunction with FIGS. 4A-4B. In turn, the smart home systems 112-1/112-2 can utilize the personalized AI models 124 over time and gather, generate, etc., feedback information 502-1/502-2 that is relevant to the performance of the personalized AI models 124. According to some embodiments, the feedback information 502-1/502-2 can include, for example, utilization metrics, prediction accuracy metrics, or some combination thereof, associated with the first and second global AI models 106-1/106-2, respectively. The feedback information 502-1/502-2 can be analyzed by the server computing device(s) 102 to identify whether the global AI model 106-1 performed better than the global AI model 106-2 (or vice-versa). In turn, the management entity 104 can adjust how the global embeddings 110 are formed/managed, adjust how the training engine(s) 108 are managed/configured, adjust how the global AI models 106 are managed/configured, adjust how the local embeddings 120 are formed/managed, adjust how the personalization engines 122 are managed/configured, adjust how the personalized AI models 124 are managed/configured, and/or the like. With these adjustments, the management entity 104 can establish, train, fine-tune, etc., global AI models 106 for distribution to the smart home systems 112, which can then establish, train, fine-tune, etc., the personalized AI models 124. The smart home systems 112 can then provide additional feedback information 502, and the aforementioned procedures can be carried out on a repeated basis such that the various AI-based embeddings, engines, models, etc., are improved over time.

FIG. 5B illustrates a method 550 for evolving artificial intelligence (AI) models that are utilized within smart home systems, according to some embodiments. As shown in FIG. 5B, the method 550 begins at step 552, where the server computing device 102 distributes at least (1) a first global AI model to a first subset of computing devices, and (2) a second global AI model to a second subset of computing devices, where: (i) each computing device in the first subset of computing devices generates or updates a respective local AI model based at least in part on (a) the first global AI model, and (b) a respective activity dataset managed by the computing device, and (ii) each computing device in the second subset of computing devices generates or updates a respective local AI model based at least in part on (a) the second global AI model, and (b) a respective activity dataset managed by the computing device (e.g., as described above in conjunction with FIG. 5A).

At step 554, the server computing device 102 receives first and second feedback information from at least one computing device of the first subset of computing devices and at least one computing device of the second subset of computing devices, respectively (e.g., as described above in conjunction with FIG. 5A).

At step 556, the server computing device 102 identifies, based at least in part on the first and second feedback information, a preferred AI model among the first or second global AI model (e.g., as described above in conjunction with FIG. 5A).

At step 558, the server computing device 102 causes the preferred AI model to be utilized by at least the first and second subsets of computing devices (e.g., as described above in conjunction with FIG. 5A).

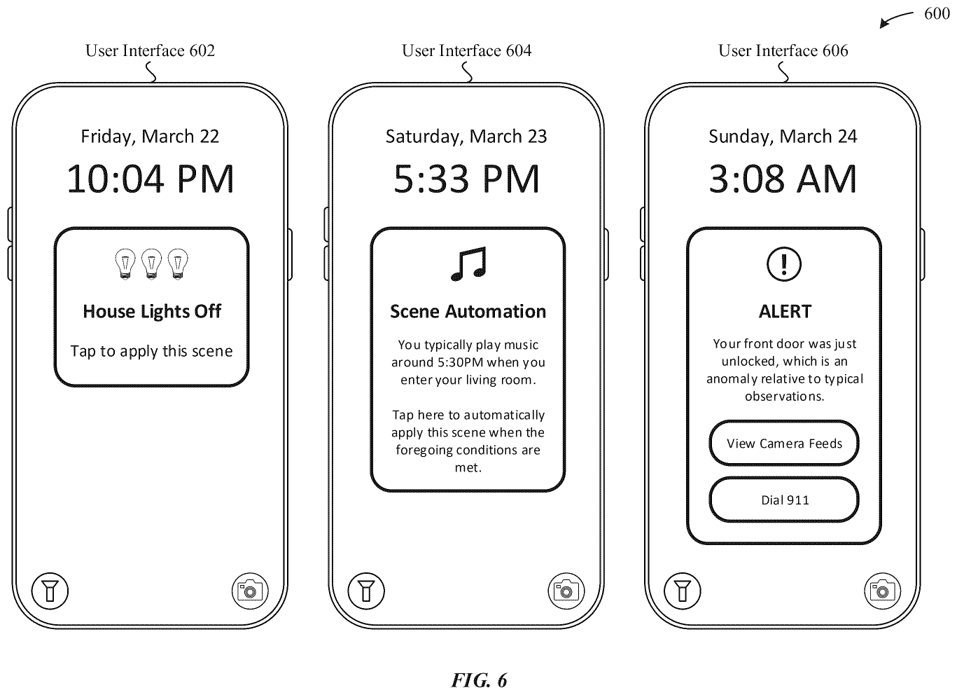

FIG. 6 illustrates conceptual diagrams 600 of user interfaces that can be utilized to enable users to interact with recommendations, according to some embodiments. For example, a user interface 602 illustrates an example approach for enabling a user to apply an ephemeral scene, e.g., when the condition(s) associated with the predictive trigger that corresponds to the ephemeral scene is/are satisfied. In another example, a user interface 604 illustrates an example approach for enabling a user to select an option to automatically apply an ephemeral scene 334 when the aforementioned condition(s) associated with the predictive trigger that corresponds to the ephemeral scene is/are satisfied. In yet another example, a user interface 606 illustrates an example approach for alerting the user when an anomaly is detected relative to the user's predicted behavior. As shown in FIG. 6, the user interface 606 can include information about the anomaly, as well as options to view camera feeds and todial 911. It is noted that the example user interfaces illustrated in FIG. 6 are not meant to be limiting, and that the user interfaces can include any amount, type, form, etc., of information, user interface elements, etc., at any level of granularity, to enable users to interact with the various features described herein, consistent with the scope of this disclosure.

FIG. 7 illustrates a detailed view of a computing device 700 that can be used to implement the various components described herein, according to some embodiments. In particular, the detailed view illustrates various components that can be included in the server computing devices 102, the centralized management hubs 114, the peripheral device hubs 126, the client devices 130, the peripheral devices 134, and the like, described herein.

As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Furthermore, the computing device 700 can include a display 710 (screen display) that can be controlled by the processor 702 to display information to the user. A data bus 716 can facilitate data transfer between at least a storage device 740, the processor 702, and a controller 713. The controller 713 can be used to interface with and control different equipment through and equipment control bus 714. The computing device 700 can also include a network/bus interface 711 that couples to a data link 712. In the case of a wireless connection, the network/bus interface 711 can include a wireless transceiver.

The computing device 700 also includes a storage device 740, which can comprise a single disk or a plurality of disks (e.g., SSDs), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities, or processes to be executed in a non-volatile manner. The RAM 720 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
by a computing device associated with a smart home system:
actively receiving smart home events associated with the smart home system; and
for each smart home event received:
providing, as input to a local artificial intelligence (AI) model, (1) the smart home event, and (2) a respective previous state output by the local AI model;
receiving, as output from the local AI model, (1) a current state, and (2) an activity prediction; and
in response to determining that a respective probability associated with the activity prediction satisfies a threshold, performing at least one action based at least in part on the activity prediction.

2. The method of claim 1, wherein, for a given smart home event received, the respective previous state is output by the local AI model in response to receiving, as input, a previous smart home event relative to the given smart home event.

3. The method of claim 1, wherein the at least one action comprises:
causing at least one smart home device associated with the smart home system to adjust at least one operational aspect of the at least one smart home device.

4. The method of claim 1, further comprising:
utilizing the local AI model to identify, among the smart home events, a subset of the smart home events that corresponds to one or more actions, wherein:
the subset of the smart home events comprises a predictive trigger; and
the one or more actions comprise an ephemeral scene; and
generating:
a first recommendation to associate the ephemeral scene with the smart home system;
a second recommendation to automatically implement the ephemeral scene when the predictive trigger is satisfied; or
some combination thereof.

5. The method of claim 4, wherein the local AI model is utilized to identify the subset of smart home events on a periodic basis or a conditional basis.

6. The method of claim 1, further comprising:
in conjunction with determining, for a given smart home event received, that the respective probability associated with the activity prediction satisfies an anomaly threshold, causing the computing device, at least one other computing device, or some combination thereof, to output at least one notification associated with the smart home event.

7. The method of claim 6, wherein the at least one notification is output in audio form, visual form, or some combination thereof, and conveys alert information about the smart home event.

8. A non-transitory computer-readable storage medium storing one or more programs configured to be executed by one or more processors of a computing device associated with a smart home system, wherein the one or more programs include instructions for:
actively receiving smart home events associated with the smart home system; and
for each smart home event received:
providing, as input to a local artificial intelligence (AI) model, (1) the smart home event, and (2) a respective previous state output by the local AI model;
receiving, as output from the local AI model, (1) a current state, and (2) an activity prediction; and
in response to determining that a respective probability associated with the activity prediction satisfies a threshold, performing at least one action based at least in part on the activity prediction.

9. The non-transitory computer-readable storage medium of claim 8, wherein, for a given smart home event received, the respective previous state is output by the local AI model in response to receiving, as input, a previous smart home event relative to the given smart home event.

10. The non-transitory computer-readable storage medium of claim 8, wherein the at least one action comprises:
causing at least one smart home device associated with the smart home system to adjust at least one operational aspect of the at least one smart home device.

11. The non-transitory computer-readable storage medium of claim 8, wherein the one or more programs include instructions for:
utilizing the local AI model to identify, among the smart home events, a subset of the smart home events that corresponds to one or more actions, wherein:
the subset of the smart home events comprises a predictive trigger; and
the one or more actions comprise an ephemeral scene; and
generating:
a first recommendation to associate the ephemeral scene with the smart home system;
a second recommendation to automatically implement the ephemeral scene when the predictive trigger is satisfied; or
some combination thereof.

12. The non-transitory computer-readable storage medium of claim 11, wherein the local AI model is utilized to identify the subset of smart home events on a periodic basis or a conditional basis.

13. The non-transitory computer-readable storage medium of claim 8, wherein the one or more programs include instructions for:
in conjunction with determining, for a given smart home event received, that the respective probability associated with the activity prediction satisfies an anomaly threshold, causing the computing device, at least one other computing device, or some combination thereof, to output at least one notification associated with the smart home event.

14. The non-transitory computer-readable storage medium of claim 13, wherein the at least one notification is output in audio form, visual form, or some combination thereof, and conveys alert information about the smart home event.

15. A computing device associated with a smart home system, the computing device comprising:
one or more processors; and
memory storing one or more programs configured to be executed by the one or more processors, the one or more programs including instructions for:
actively receiving smart home events associated with the smart home system; and
for each smart home event received:
providing, as input to a local artificial intelligence (AI) model, (1) the smart home event, and (2) a respective previous state output by the local AI model;
receiving, as output from the local AI model, (1) a current state, and (2) an activity prediction; and
in response to determining that a respective probability associated with the activity prediction satisfies a threshold, performing at least one action based at least in part on the activity prediction.

16. The computing device of claim 15, wherein, for a given smart home event received, the respective previous state is output by the local AI model in response to receiving, as input, a previous smart home event relative to the given smart home event.

17. The computing device of claim 15, wherein the at least one action comprises:
causing at least one smart home device associated with the smart home system to adjust at least one operational aspect of the at least one smart home device.

18. The computing device of claim 15, wherein the one or more programs include instructions for:
utilizing the local AI model to identify, among the smart home events, a subset of the smart home events that corresponds to one or more actions, wherein:
the subset of the smart home events comprises a predictive trigger; and
the one or more actions comprise an ephemeral scene; and
generating:
a first recommendation to associate the ephemeral scene with the smart home system;
a second recommendation to automatically implement the ephemeral scene when the predictive trigger is satisfied; or
some combination thereof.

19. The computing device of claim 18, wherein the local AI model is utilized to identify the subset of smart home events on a periodic basis or a conditional basis.

20. The computing device of claim 15, wherein the one or more programs include instructions for:
in conjunction with determining, for a given smart home event received, that the respective probability associated with the activity prediction satisfies an anomaly threshold, causing the computing device, at least one other computing device, or some combination thereof, to output at least one notification associated with the smart home event.

21. The computing device of claim 20, wherein the at least one notification is output in audio form, visual form, or some combination thereof, and conveys alert information about the smart home event.
